(19) United States
(12) Patent Application Publication
(10) Pub. No.: US 2025/0163883 A1
(43) Pub. Date: May 22, 2025

(54) WIND ROUTERS FOR VERTICAL WIND TURBINES

(71) Applicant: FONDACIJA MOZAIK, Sarajevo (BA)

(72) Inventors: SILMIJA FERIZOVIC TOPOLJAK, Bilhac (BA); SAMIDA FERIZOVIC, Bilhac (BA); HARUN FERIZOVIC, Bilhac (BA)

(73) Assignee: FONDACIJA MOZAIK, Sarajevo (BA)

(21) Appl. No.: 18/870,826

(22) PCT Filed: Apr. 21, 2020
(86) PCT No.: PCT/BA2020/000003

§ 371 Date: Dec. 2, 2024

(30) Foreign Application Priority Data
Apr. 24, 2019 (BA) BAP193312A

(51) Int. Cl. F03D 3/04; F03D 3/00

(52) U.S. Cl. CPC F03D 3/0436; F03D 3/009; F05B 2240/213; F05B 2240/3052

(57) ABSTRACT

Wind turbines for vertical wind turbines, that is, self-adjusting stationary blades and wind routers which further enhance the operation and efficiency of each wind turbine on the main axis of the turbine. Depending on the height of the turbine, there may be one or more routers, depending on the height of the turbine, taking into account the rotor height of about 3 meters, it would have 3 wind routers of 1 m each.

### FIELD OF THE INVENTION

The present invention relates to wind routers for vertical wind turbines and according to the International Classification (IPC) is classified as F03D 3/00, F03D 9/00.

### Technical Problem

The existing Savonius turbine has a problem, which is a negative resistance on the convex side of the coil. This negative resistance implies that the turbine does not reach the maximum rotation that could result in no resistance. The solution to this problem was found in changing the construction of a standard Savonius turbine by positioning it on a secondary axle which, in addition to rotating itself around its axis, also turns around the main axis on which wind routers are located, which with its specially designed design directs it to an ideal position in relation to the wind direction. In this way, the negative resistance is avoided and the effect of the thrust, that is, the pulling of the rotor, directly behind the negative side of the rotor is achieved.

### BACKGROUND OF THE INVENTION

A similar principle of using additional wind energy was recognized by Japanese Yuju Ohya from Kyushu University in Japan. The technology is called “Wind Lens” and has been applied to horizontal three-axis wind turbines and is designed to increase wind power output by 2-3 times. There is no known similar solution on vertical wind turbines.

### SUMMARY OF THE INVENTION

The present and new vertical wind turbine with self-adjusting stationary blades is a turbine that roughly equates to the HAWT horizontal turbines most used in the world today, in terms of wind power utilization. The production of vertical wind turbines and their use on the market is increasingly present for a number of reasons, advantages for a particular target market, starting with the price itself, the method of production and its efficiency. The facts present were a challenge for this team, so an innovative approach to the already existing type of axial vertical wind turbine was made and a vertical wind router was added. The way to avoid, or minimize, the negative resistance on the convex side of the coil is to incorporate a wind router into the wind turbine structure that positions the turbine in an ideal position relative to the wind direction. In this way, a part of the wind current from the convex side of the blade is directed to the concave side, and a part of the wind current is diverted to the side opposite to rotation, which causes a pressure that increases the wind utilization.

### BRIEF DESCRIPTION OF THE DRAWINGS

The images which come within the description and explanation of the invention are as follows:

FIG. 1 is a spatial view of the main axis and the wind router.

FIG. 2—spatial view of main axis and router—disassembled.

FIG. 3 is a blueprint, floor plan, and side elevation of a router with its spatial representation.

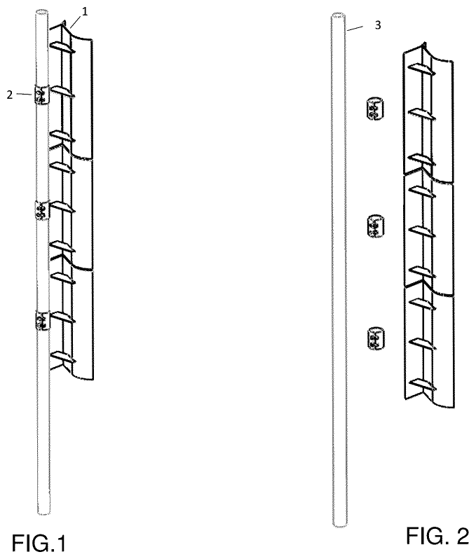

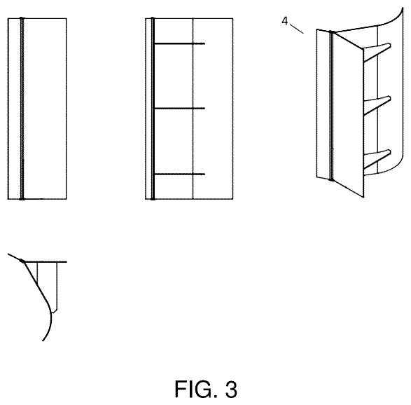

### SUMMARY OF THE INVENTION

Wind routers are relatively easy to make. They are made of sheets of sheet metal that bend at exactly the right angle, providing a blade design that directs the turbine to an ideal position relative to the wind direction. To mount the router on the main shaft, it is also necessary to create router supports. The supports are made of tubes of certain cross-section and wall thickness. The router bracket is welded to the wind router and screwed to the main shaft. On the back of the wind rotor, movable flaps have been added, which are screwed to the wind routers, and this allows additional turbine routing.

The wind router is added to the existing savonius turbines in such a way that it is mounted on the main shaft, and the turbine rotor itself is ejected into the secondary shaft which, in addition to being rotary about its axis, becomes rotary about the main shaft and router and is thus positioned in ideal position relative to wind direction.

### LIST OF USED LABELS AND REFERENCES

1—wind router (3 pcs.)
2—router carrier (3 pcs.)
3—main axle (1 pc)
4—movable flap (3 pcs.)

1. A wind router, characterized in that it is positioned on the main axis of the turbine (3), with the possibility that there may be one or more routers (1) on the main axis, depending on the height of the turbine, which is welded to the wind router carrier (2) made of tubes of certain cross-section and wall thickness, and positioned on the main shaft by a screw connection, in which the router plate is bent in two parts, where one part is straight, and is used to direct the wind from the convex part of the savonius rotor, which is undesirable to us, into the concave part of the savonius rotor, while the other side of the blades is slightly curved, and with its curvature causes a whirlwind of wind, thereby achieving the effect of pressure, ie. of pulling the turbine rotor in which way the part of the wind which is on the convex side of the savonius rotor is diverted or positively utilized.

2. The wind router according to claim 1, characterized in that at the point where the router breaks into two parts there is a movable flap (4) which enters into the component of the router and in that way further positions the turbine rotor.
